(19) United States
(12) Patent Application Publication
(10) Pub. No.: US 2026/0119996 A1
(43) Pub. Date: Apr. 30, 2026

(54) METHOD FOR SELECTING MODEL INPUT FEATURE, APPARATUS, DEVICE, AND STORAGE MEDIUM

(71) Applicant: CHINA UNIONPAY CO., LTD., Shanghai (CN)

(72) Inventors: Yuanjian ZHANG, Shanghai (CN); Yadan DING, Shanghai (CN); Zhongzheng CHEN, Shanghai (CN); Yongkai ZHOU, Shanghai (CN); Pengfei GAO, Shanghai (CN); Quan SUN, Shanghai (CN)

(21) Appl. No.: 19/474,122

(22) PCT Filed: Mar. 20, 2024
(86) PCT No.: PCT/CN2024/082589

§ 371 Date: Oct. 9, 2025

(30) Foreign Application Priority Data
Apr. 10, 2023 (CN) 202310383618.X

(51) Int. Cl. G06N 20/00

(52) U.S. Cl. CPC G06N 20/00

(57) ABSTRACT

The present application discloses a method for selecting a model input feature, apparatus, device, and storage medium, and relates to the field of big data processing. The method comprises: acquiring a candidate feature, feature data comprising the candidate feature, and an original binning point of an original bin for a value of the candidate feature; constructing a critical bin based on the original binning point; obtaining a first model input performance index according to the value of the candidate feature in the feature data and the critical bin, wherein the first model input performance index comprises a model input performance index of the candidate feature in the critical bin; and selecting the model input feature from the candidate feature according to the first model input performance index of the candidate feature and a pre-acquired second model input performance index of the candidate feature.

### CROSS REFERENCE TO RELATED APPLICATION

This application is a National Stage of International Application No. PCT/CN2024/082589, filed on Mar. 20, 2024, which claims priority to Chinese Patent Application No. 202310383618.X, filed on Apr. 10, 2023 and entitled “METHOD FOR SELECTING MODEL INPUT FEATURE, APPARATUS, DEVICE, AND STORAGE MEDIUM”, both of which are hereby incorporated by reference in its entireties.

### TECHNICAL FIELD

The present application belongs to the field of big data processing, and in particular, relates to a method for selecting a model input feature, apparatus, device, and storage medium.

### BACKGROUND

With the continuous development of artificial intelligence technology, more and more services may be led or assisted by trained models. The performance of a model, such as accuracy and stability, is closely related to model input features for model training. In order to select appropriate model input features, values of features may be divided by a binning method, and whether the features may serve as model input features for model training may be determined based on the performances of the features in bins.

### SUMMARY

In a first aspect, some embodiments of the present application provide a method for selecting a model input feature, including: acquiring a candidate feature, feature data including the candidate feature, and an original binning point of an original bin for a value of the candidate feature; constructing a critical bin based on the original binning point, where the critical bin is obtained by extension from the original binning point into two corresponding adjacent original bins; obtaining a first model input performance index according to the value of the candidate feature in the feature data and the critical bin, where the first model input performance index includes a model input performance index of the candidate feature in the critical bin; and selecting the model input feature from the candidate feature according to the first model input performance index of the candidate feature and a pre-acquired second model input performance index of the candidate feature, wherein the second model input performance index includes a model input performance index of the candidate feature in the original bin.

In a second aspect, some embodiments of the present application provide an apparatus for selecting a model input feature, including: an acquisition module configured to acquire a candidate feature, feature data including the candidate feature, and an original binning point of an original bin for a value of the candidate feature: a bin construction module configured to construct a critical bin based on the original binning point, where the critical bin is obtained by extension from the original binning point into two corresponding adjacent original bins; an index calculation module configured to obtain a first model input performance index according to the value of the candidate feature in the feature data and the critical bin, where the first model input performance index includes a model input performance index of the candidate feature in the critical bin; and a selection module configured to select the model input feature from the candidate feature according to the first model input performance index of the candidate feature and a pre-acquired second model input performance index of the candidate feature, wherein the second model input performance index comprises a model input performance index of the candidate feature in the original bin.

In a third aspect, an embodiment of the present application provides an electronic device including: a processor and a memory storing computer program instructions, where the processor, when executing the computer program instructions, implements the method for selecting a model input feature in the first aspect.

In a fourth aspect, an embodiment of the present application provides a computer-readable storage medium, the computer-readable storage medium storing computer program instructions, and the computer program instructions, when executed by a processor, implementing the method for selecting a model input feature in the first aspect.

### BRIEF DESCRIPTION OF THE DRAWINGS

In order to illustrate the technical solutions of the embodiments of the present application more clearly, the accompanying drawings required for use in the embodiments of the present application will be briefly introduced below. A person of ordinary skill in the art may derive other drawings based on these drawings without any creative efforts.

FIG. 1 is a flowchart of a method for selecting a model input feature provided in an embodiment of the present application;

FIG. 2 is a schematic diagram of an example of original bins and critical bins provided in an embodiment of the present application:

FIG. 3 is a flowchart of a method for selecting a model input feature provided in another embodiment of the present application:

FIG. 4 is a flowchart of a method for selecting a model input feature provided in still another embodiment of the present application:

FIG. 5 is a flowchart of a method for selecting a model input feature provided in still another embodiment of the present application:

FIG. 6 is a flowchart of an example of a process of selecting a model input feature provided in an embodiment of the present application:

FIG. 7 is a schematic structural diagram of an apparatus for selecting a model input feature provided in an embodiment of the present application; and

FIG. 8 is a schematic structural diagram of an electronic device provided in an embodiment of the present application.

### DETAILED DESCRIPTION

The features and exemplary embodiments of various aspects of the present application will be described in detail below. In order to make the objectives, technical solutions, and advantages of the present application clearer, the present application will be further described in detail below in conjunction with the accompanying drawings and specific embodiments. It should be understood that the specific embodiments described here are merely intended to explain the present application, but not to limit the present application. For those skilled in the art, the present application may be implemented without some of these specific details. The following descriptions of the embodiments are merely for providing a better understanding of the present invention by showing examples of the present invention.

With the continuous development of artificial intelligence technology, more and more services may be led or assisted by trained models. The performance of a model, such as accuracy and stability; is closely related to model input features for model training. In order to select appropriate model input features, values of the features may be divided by a binning method, and whether the features may serve as model input features for model training may be determined according to the performances of the features in bins. However, binning points and values near the binning points are close to bin edges, making it difficult to evaluate the performance of the features at binning points and the values near the binning points. Thus the evaluation of the performance of the features is inaccurate, leading to inadequacies in the selection process of model input features. Consequently, the accuracy of models trained with these selected features is reduced.

The present application provides a method for selecting a model input feature, apparatus, device, and storage medium, where a critical bin may be constructed based on a binning point for original bins, the binning point and values near the binning point are located in the middle of the critical bin, evaluations of features in the critical bin are acquired, and model input features are jointly determined by evaluations of the features in the original bins and the evaluations of the features in the critical bin, compensating for deficiencies induced by performance loss of the binning point and the values near the binning point in the process of model input feature selection, improving the effectiveness of model input feature selection, and thus improving the performance of a model trained with the selected model input features, such as accuracy and stability.

Below are explanations of the method for selecting a model input feature, apparatus, device, and storage medium provided in the present application.

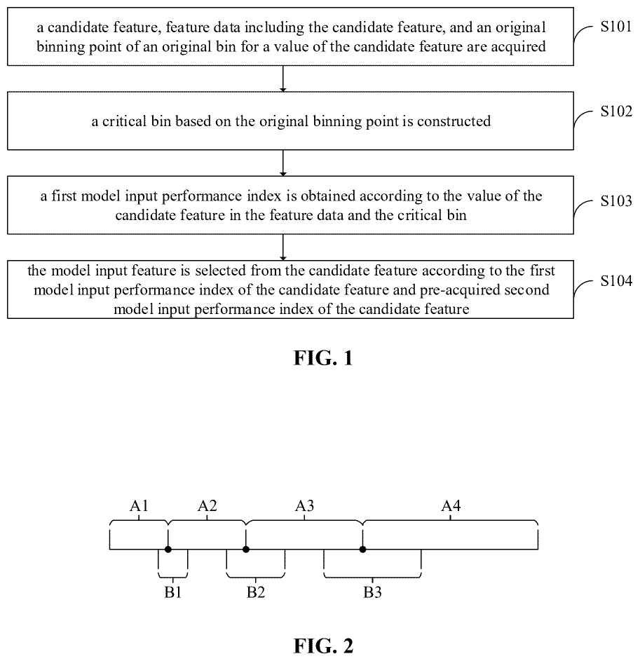

In a first aspect, the present application provides a method for selecting a model input feature, which may be used in scenarios where model input features are selected for model training. The method may specifically be executed by, but not limited to, an apparatus for selecting a model input feature, an electronic device, or the like. FIG. 1 is a flowchart of a method for selecting a model input feature provided in an embodiment of the present application. As shown in FIG. 1, the method for selecting a model input feature may include steps S101 to S104.

In step S101, a candidate feature, feature data including the candidate feature, and an original binning point of an original bin for a value of the candidate feature are acquired.

The candidate feature includes a feature as a candidate option of the model input feature. In the embodiments of the present application, the candidate feature may include a continuous feature and/or a discontinuous feature with multiple discrete values. The model input feature is a feature used for model training. The feature data include the candidate feature. In some examples, the feature data may further include other data, which is not limited herein. Each feature data may reflect, but not limited to, a corresponding service, user, etc. The value of the same candidate feature corresponding to different services or different users may be different or the same.

The original bin is a bin for the candidate feature. The original bin may be obtained by, but not limited to, equal frequency binning, equidistant binning, cluster binning, etc. The original binning point includes a binning point between original bins, the binning point is a boundary point of two consecutive bins, and each original binning point corresponds to two adjacent original bins. For example, four original bins are obtained by equal frequency binning: [0, 300), [300, 800), [800, 2500), and [2500, 10000), and four original bins yield three original binning points: 300, 800, and 2500, where two adjacent original bins corresponding to the original binning point 300 include [0, 300) and [300, 800), two adjacent original bins corresponding to the original binning point 800 include [300, 800) and [800, 2500), and two adjacent original bins corresponding to the original binning point 800 include [800, 2500) and [2500, 10000).

In step S102, a critical bin is constructed based on the original binning point.

A critical bin is obtained by extension from the original binning point into two corresponding adjacent original bins, so that the original binning point and values near the original binning point are located in the middle of the critical bin. The extension is from the original binning point as a reference point towards both sides to obtain the critical bin. FIG. 2 is a schematic diagram of an example of original bins and critical bins provided in an embodiment of the present application. Black dots in FIG. 2 represent original binning points. As shown in FIG. 2, the original bins include areas A1, A2, A3, and A4, while the critical bins include areas B1, B2, and B3. The lower limit of the critical bin may be a boundary value of the extension from the original binning point into the lower one of two adjacent original bins, and the upper limit of the critical bin may be a boundary value of the extension from the original binning point into the higher one of two adjacent original bins. For example, the original binning point is 300, two adjacent original bins corresponding to the original binning point 300 include [0, 300) and [300, 800), and then the critical bin obtained from the original binning point may be [280, 330).

In step S103, a first model input performance index is obtained according to the value of the candidate feature in the feature data and the critical bin.

The first model input performance index includes a model input performance index of the candidate feature in the critical bin. The model input performance index may characterize the performance of a feature for training a model, which may include predictive ability, stability, discernibility ability, differentiation, etc. The type of the model input performance index is not limited herein, and all model input performance indexes that may characterize the performance of features for training the model fall within the scope of protection of the embodiments of the present application. For example, the model input performance index may include one or more of the following: an information value (IV), a population stability index (PSI), a Kolmogorov-Smirnov (KS) statistic, and an area under curve (AUC). The information value may measure the ability of a single feature to distinguish categories on each bin. The population stability index may measure whether there is a significant difference in the category distribution of two datasets on each bin. The KS statistic and the area under curve may measure the ability of features to distinguish categories. The embodiments of the present application are compatible with model input evaluation indexes of various features.

In step S104, the model input feature is selected from the candidate feature according to the first model input performance index of the candidate feature and pre-acquired second model input performance index of the candidate feature.

The second model input performance index includes a model input performance index of the candidate feature in the original bin. The specific content of the model input performance index may be referenced to the above, and will not be repeated here.

The first model input performance index may characterize the model input performance index of the candidate feature in the critical bin, and the second model input performance index may characterize the model input performance index of the candidate feature in the original bin. The first model input performance index may compensate for the difficulty of evaluating the original binning point and the values near the original binning point through the second model input performance index. In some examples, a combined model input performance index may be obtained according to the first model input performance index and the second model input performance index. The combined model input performance index may be used to determine whether the candidate feature should be selected as a model input feature. By combining the first model input performance index and the second model input performance index to determine the model input feature in the candidate feature, the effectiveness of model input feature selection can be improved.

In the embodiments of the present application, based on the original binning point of the original bin for the candidate feature, the critical bin can be obtained by extension from the original binning point into two corresponding adjacent original bins, the first model input performance index of the candidate feature in the critical bin is obtained according to the value of the candidate feature in the feature data and the critical bin, and the model input feature is selected from the candidate feature according to the first model input performance index and second model input performance index of the candidate feature. The original binning point and the values near the original binning point are within the critical bin, and the first model input performance index may characterize the performance of the candidate feature in the critical bin, so the first model input performance index may be used to compensate for missing evaluation of the original binning point and the values near the original binning point by the second model input performance index that characterizes the performance of the candidate feature in the original bin. The combination of the first model input performance index and the second model input performance index can evaluate the candidate feature more comprehensively and accurately, refine the selection process of the model input feature, and improve the effectiveness of model input feature selection, thereby improving the accuracy and stability of a model trained with the selected model input features. Especially in linear model application scenarios such as logistic regression, the classification accuracy of the model trained with the selected model input features against adversarial samples can be further enhanced.

Moreover, the method for selecting a model input feature in the embodiments of the present application does not need to determine a data offset of the original bin, or adjust the evaluation on the feature in the original bin, or modify the evaluation process of the original bin, but can achieve relatively good effects with minimal influence on the original process of model input feature selection. The method for selecting a model input feature in the embodiments of the present application may be applied to a federated modeling scenario. The determination of the model input feature does not require additional model training, which can reduce the overhead, especially in the federated modeling scenario.

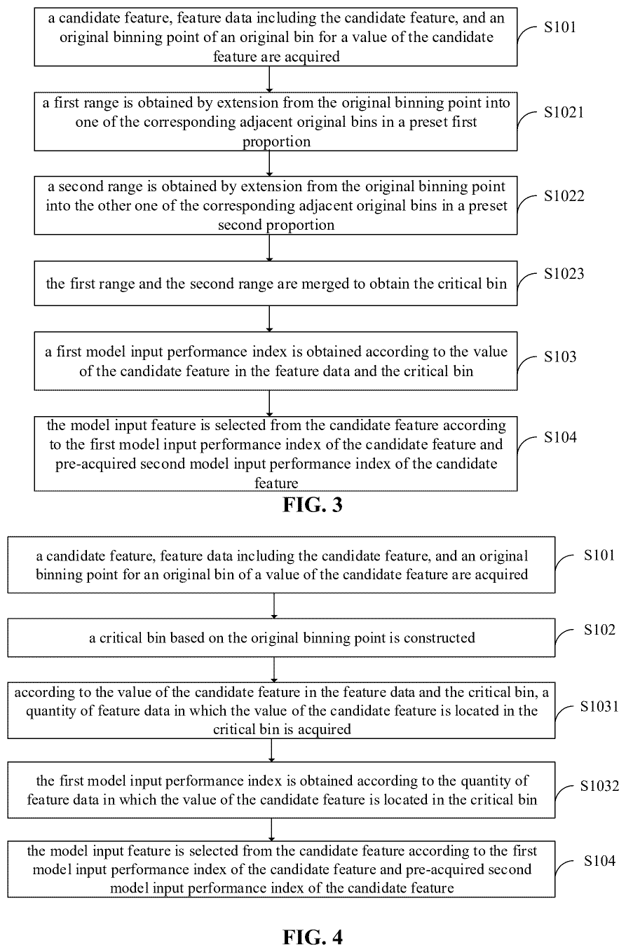

In some embodiments, the critical bin is constructed by extension from the original binning point into two corresponding adjacent original bins according to a certain proportion. FIG. 3 is a flowchart of a method for selecting a model input feature provided in another embodiment of the present application. FIG. 3 differs from FIG. 1 in that step S102 in FIG. 1 may be specifically embodied in steps S1021 to S1023 in FIG. 3.

In step S1021, a first range is obtained by extension from the original binning point into one of the corresponding adjacent original bins in a preset first proportion.

The first proportion is a ratio of the first range to a range of the one of the corresponding adjacent original bins, and may be set according to, but not limited to, specific scenarios, needs, experience. In some examples, the first proportion may be less than or equal to 10%. The first range is a portion of one original bin corresponding to the original binning point.

In step S1022, the extension is from the original binning point into the other one of the corresponding adjacent original bins in a preset second proportion to obtain a second range.

The second proportion is a ratio of the second range to a range of the other one of the corresponding adjacent original bins, and may be set according to, but not limited to, specific scenarios, needs, experience, etc. In some examples, the second proportion may be less than or equal to 10%. The second range is a portion of the other original bin corresponding to the original binning point. The second proportion may be the same as or different from the first proportion, which is not limited herein.

When the first range is a portion of the lower original bin in two adjacent original bins corresponding to the original binning point, that is, when the original binning point is a right endpoint of the lower original bin, the second range is a portion of the higher original bin in two adjacent original bins corresponding to the original binning point, that is, the original binning point is a left endpoint of the higher original bin. Alternatively, when the first range is a portion of the higher original bin in two adjacent original bins corresponding to the original binning point, that is, when the original binning point is a left endpoint of the lower original bin, the second range is a portion of the lower original bin in two adjacent original bins corresponding to the original binning point, that is, the original binning point is a right endpoint of the higher original bin.

In step S1023, the first range and the second range are merged to obtain the critical bin.

For ease of understanding, an example is provided below to illustrate the first range, the second range, and the critical bin. If two adjacent original bins are [aᵢ₋₁, aᵢ) and [aᵢ, aᵢ₊₁), the left endpoint and right endpoint of the critical bin corresponding to the original binning point aᵢ may be obtained according to equations (1) and (2) below:

$${la}_{i} = {a}_{i} - p \times ( {a}_{i} - {a}_{i - 1} ) \qquad ( 1 )$$

$${ra}_{i} = {a}_{i} + q \times ( {a}_{i + 1} - {a}_{i} ) \qquad ( 2 )$$

where aᵢ represents the original binning point: laᵢ represents the left endpoint of the critical bin corresponding to the original binning point aᵢ; raᵢ represents the right endpoint of the critical bin corresponding to the original binning point aᵢ; p represents the first proportion; and q represents the second proportion. According to equations (1) and (2) above, the first range is [laᵢ, aᵢ), the second range is [aᵢ, raᵢ), and the critical bin corresponding to the original binning point aᵢ is [laᵢ, raᵢ).

For example, if four consecutive original bins are [0, 300), [300, 800), [800, 2500), and [2500, 10000), the first proportion and the second proportion are the same and both are 5%, according to equations (1) and (2) above, the critical bin corresponding to the original binning point 300 is [285, 325], the critical bin corresponding to the original binning point 800 is [775, 885], and the critical bin corresponding to the original binning point 2500 is [2415, 2875].

In some embodiments, the first model input performance index can be obtained according to the quantity of feature data in which the value of the candidate feature falls into the critical bin. FIG. 4 is a flowchart of a method for selecting a model input feature provided in still another embodiment of the present application. FIG. 4 differs from FIG. 1 in that step S103 in FIG. 1 may be specifically embodied in steps S1031 and S1032 in FIG. 4.

In step S1031, according to the value of the candidate feature in the feature data and the critical bin, the quantity of feature data in which the value of the candidate feature is located in the critical bin is acquired.

When the value of the candidate feature in part of extensive feature data is within the critical bin, it may be considered that the feature data belong to the critical bin, and the quantity of feature data belonging to each critical bin may be counted. The quantity of feature data in which the value of the candidate feature is within the critical bin is the quantity of feature data belonging to the critical bin. A piece of feature data may include, but not limited to, data of one user or data about the execution of a service by one user once.

In some examples, the feature data has classification labels, and the classification labels are used to indicate classification results of the feature data. The classification results correspond to the classification results that the model can support, and the classification labels of the feature data indicate actual classification results. The quantity of feature data in which the value of the candidate feature is located in the critical bin may include the quantity of feature data with the same classification label in the critical bin. For example, the quantity of feature data located in the critical bin B1 is 100. Among one hundred feature data, the quantity of feature data with classification label “category 1” is 65, and the quantity of feature data with classification label “category 2” is 35. If each feature data includes data of one user, it may be considered that the quantity of users belonging to the critical bin B1 is 100. Among one hundred users belonging to the critical bin B1, there are 65 users having the classification label of the feature data that is “category 1”, and 35 users having the classification label of the feature data that is “category 2”.

In step S1032, the first model input performance index is obtained according to the quantity of feature data in which the value of the candidate feature is located in the critical bin.

The first model input performance index of the candidate feature may characterize the performance of the candidate feature for training the model. The performance of the candidate feature in the critical bin, such as discernibility ability and stability, may be determined by a relationship between the quantities of feature data in the critical bin.

In some embodiments, the feature data has classification labels. The specific description of the classification labels may be referenced to the above, and will not be repeated here. A first quantity of feature data having the same classification label is acquired from the feature data in the critical bin; a second quantity of feature data having the same classification label is acquired from the feature data; and the first model input performance index is obtained according to the first quantity and the second quantity.

For the feature data in any critical bin, the feature data under each classification label in the critical bin may be acquired, and the quantity of feature data under each classification label in the critical bin may be counted. The first quantity includes a quantity of feature data under each classification label in the critical bin. The second quantity may be a total quantity of feature data having the same classification label in each critical bin. The first model input performance index may be obtained by a proportional relationship between the first quantity and the second quantity corresponding to each classification label.

In some examples, the classification labels include a first classification label and a second classification label, and the first classification label and the second classification label indicate different classification results. A first ratio of the first quantity corresponding to the first classification label to the second quantity corresponding to the first classification label is acquired; a second ratio of the first quantity corresponding to the second classification label to the second quantity corresponding to the second classification label is acquired; and the first model input performance index is obtained according to the first ratio and the second ratio. For example, the first model input performance index includes an information value, the classification labels of feature data include a first classification label and a second classification label, the first classification label represents “category 1”, the second classification label represents “category 2”, then the information value of the candidate features in the i-th critical bin may be obtained according to equation (3) below:

$${TIV}_{i} = ( \frac{{G}_{i}}{G} - \frac{{B}_{i}}{B} ) ln \frac{{G}_{i} / G}{{B}_{i} / B} \qquad ( 3 )$$

where TIVᵢ represents the information value of the candidate features in the i-th critical bin; Gᵢ represents the first quantity of feature data with the first classification label in the i-th critical bin; G represents the second quantity of feature data with the first classification label among all the feature data; Bᵢ represents the first quantity of feature data with the second classification label in the i-th critical bin; B represents the second quantity of feature data with the second classification label among all the feature data:

$$\frac{{G}_{i}}{G}$$

represents the first ratio, and

$$\frac{{B}_{i}}{B}$$

represents the second ratio.

For another example, the first model input performance index includes a population stability index, the classification labels of feature data include a first classification label and a second classification label, the first classification label represents “category 1”, the second classification label represents “category 2”, then the population stability index of the candidate features in the i-th critical bin may be obtained according to equation (4) below:

$${TPSI}_{i} = ( \frac{{G}_{i}}{G} - {d}_{1} ) ln \frac{{G}_{i} / G}{{d}_{1}} + ( \frac{{B}_{i}}{B} - {d}_{2} ) ln \frac{{G}_{i} / G}{{d}_{2}} \qquad ( 4 )$$

where TPSIᵢ represents the population stability index of the candidate features in the i-th critical bin; Gᵢ represents the first quantity of feature data with the first classification label in the i-th critical bin; G represents the second quantity of feature data with the first classification label among all the feature data; d₁ represents a desired proportion of the feature data with the first classification label among the feature data; Bᵢ represents the first quantity of feature data with the second classification label in the i-th critical bin; B represents the second quantity of feature data with the second classification label among all the feature data; d₁ represents a desired proportion of the feature data with the second classification label among the feature data;

$$\frac{{G}_{i}}{G}$$

represents the first ratio; and

$$\frac{{B}_{i}}{B}$$

represents the second ratio.

Other types of the first model input performance indexes are calculated in a similar way, and may be obtained according to the method for calculating a model input performance index. Details will not be elaborated here.

The classification labels of feature data are not limited to two, but may be greater than two, that is, the classification results of feature data may be greater than two types. In some examples, the classification labels include a first classification label to an N-th classification label, where N is an integer greater than 2, and the first classification label to the N-th classification label indicate different classification results. For each of every two classification labels from the first classification label to the N-th classification label, a model input performance factor term corresponding to two classification labels is calculated according to a ratio of the first quantity to the second quantity corresponding to two classification labels; and a sum of the model input performance factor terms corresponding to every two classification labels from the first classification label to the N-th classification label is determined as the first model input performance index. For example, the first model input performance index includes an information value, the classification labels of feature data include a first classification label to an N-th classification label, the first classification label to the N-th classification label represent “category 1” to “category N” respectively, then the information value of the candidate feature in the i-th critical bin may be obtained according to equation (5) below:

$${TIV}_{i} = {\sum }_{j = 1 , 2 , … , N , k = 1 , 2 , … , N , j \neq k} ( \frac{{G}_{i j}}{{G}_{j}} - \frac{{G}_{i k}}{{G}_{k}} ) ln \frac{{G}_{i j} / {G}_{j}}{{G}_{i k} / {G}_{k}} \qquad ( 5 )$$

where TIVᵢ represents the information value of the candidate feature in the i-th critical bin; Gᵢⱼ represents the first quantity of feature data with the j-th classification label in the i-th critical bin; Gⱼ represents the second quantity of feature data with the j-th classification label among all the feature data; Gᵢₖ represents the first quantity of feature data with the k-th classification label in the i-th critical bin; Gₖ represents the second quantity of feature data with the k-th classification label among all the feature data; and

$$( \frac{{G}_{i j}}{{G}_{j}} - \frac{{G}_{i k}}{{G}_{k}} ) ln \frac{{G}_{i j} / {G}_{j}}{{G}_{i k} / {G}_{k}}$$

represents the model input performance factor term corresponding to the j-th classification label and the k-th classification label.

When there are more than 2 classification labels, other types of first model input performance indexes are calculated in a similar way, and may be obtained according to the method for calculating a model input performance index. Details will not be elaborated here.

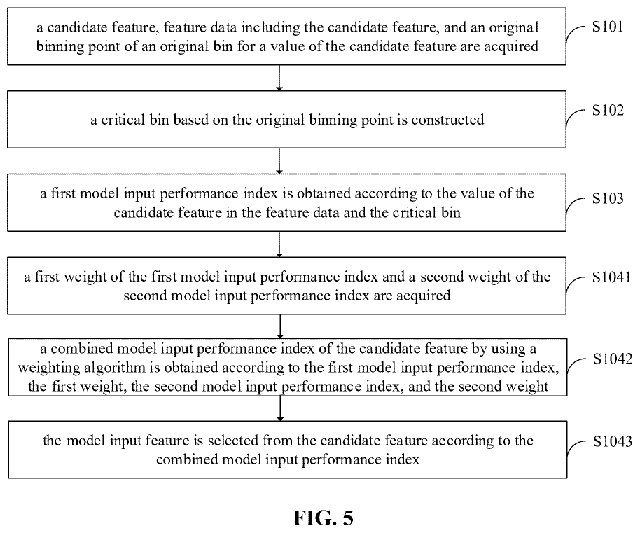

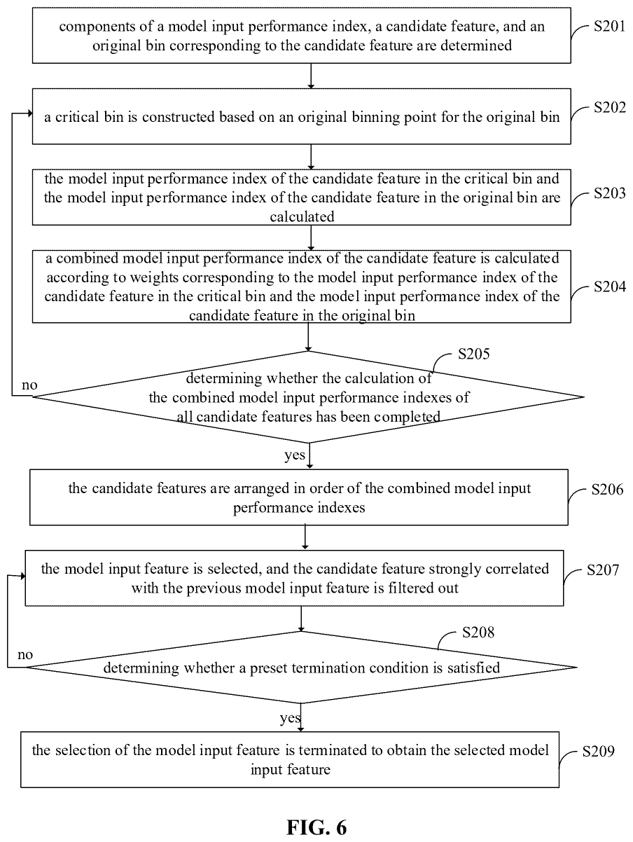

In some embodiments, the first model input performance index and the second model input performance index may be combined with respective weights to obtain a combined model input performance index of the candidate feature. FIG. 5 is a flowchart of a method for selecting a model input feature provided in still another embodiment of the present application. FIG. 5 differs from FIG. 1 in that step S104 in FIG. 1 may be specifically embodied in steps S1041 to S1043 in FIG. 5.

In step S1041, a first weight of the first model input performance index and a second weight of the second model input performance index are acquired.

The first weight is a weight corresponding to the first model input performance index. The second weight is a weight corresponding to the second model input performance index. A sum of the first weight and the second weight is 1. The first weight and the second weight may be set according to, but not limited to, a demand for model input features, a usage scenario of model input features, a demand of a model trained with model input features, a usage scenario of a model trained with model input features, experience, etc.

In step S1042, a combined model input performance index of the candidate feature by using a weighting algorithm is obtained according to the first model input performance index, the first weight, the second model input performance index, and the second weight.

The combined model input performance index may characterize the value of the candidate feature in the critical bin and a comprehensive performance of the candidate feature in the original bin. Specifically, the first model input performance indexes corresponding to each critical bin are summed to obtain a first sum; the second model input performance indexes corresponding to each original bin are summed to obtain a second sum; and the combined model input performance index is calculated according to the first sum, the first weight, the second sum, and the second weight. For example, the combined model input performance index includes an information value, and the combined model input performance index may be obtained according to equation (6) below:

$$IV = α \times {\sum }_{i = 1}^{m} {IV}_{i} + ( 1 - α ) {\sum }_{i = 1}^{m - 1} {TIV}_{i} \qquad ( 6 )$$

where IV represents the combined model input performance index; α represents the second weight; IVᵢ represents the second model input performance index corresponding to the i-th original bin; 1-α represents the first weight; and TIVᵢ represents the first model input performance index corresponding to the i-th critical bin.

In step S1043, the model input feature is selected from the candidate feature according to the combined model input performance index.

The candidate feature with the combined model input performance index satisfying a preset selection condition may be selected as the model input feature. The preset selection condition may be set according to, but not limited to, the types, scenarios, and needs of the combined model input performance indexes, experience, etc. For example, the combined model input performance index includes an information value. A larger information value indicates higher discernibility ability of the candidate feature. The preset selection condition may include that the combined model input performance index is greater than or equal to a preset information value threshold. The preset information value threshold may be set according to, but not limited to, scenarios, needs, experience, etc. For example, the preset information value threshold may be 0.5. For example, the combined model input performance index includes a population stability index. The smaller population stability index indicates higher stability of the candidate feature. The preset selection condition may include that the combined model input performance index is less than or equal to a preset population stability index threshold. The preset population stability index threshold may be set according to, but not limited to, scenarios, needs, experience, etc. For example, the preset population stability index threshold may be 0.1. The quantity of the selected model input features may be further limited. When the quantity of model input features reaches a preset required quantity; the selection of model input features is stopped.

In some examples, the candidate features may be sequentially determined as the model input features in descending order of the performance characterized by the combined model input performance indexes until a preset termination condition is satisfied. The preset termination condition may include: the combined model input performance index satisfies a preset selection condition, and/or the quantity of model input features meets a preset requirement.

When the combined model input performance indexes of a plurality of candidate features characterize different performances, the candidate features with relatively high performances characterized by the combined model input performance indexes are preferentially selected. For example, when the combined model input performance index includes an information value, the larger information value indicates higher discernibility ability of the candidate feature, the candidate features may be arranged in descending order of the information values, and the model input features may be selected in that order. For another example, when the combined model input performance index includes a population stability index, the smaller population stability index indicates higher stability of the candidate feature, the candidate features may be arranged in ascending order of the population stability indexes, and the model input features may be selected in that order.

The preset requirement may include that the quantity of model input features reaches a preset quantity, or the candidate features are already emptied, etc. The preset requirement may further include other requirements, which are not limited herein. For example, model input features are sequentially selected according to the preset selection condition in descending order of the performance characterized by the combined model input performance indexes. When the quantity of the selected model input features reaches a preset quantity, the selection of model input features is stopped, and the model may be trained with the selected model input features. For another example, model input features are sequentially selected according to the preset selection condition in descending order of the performances characterized by the combined model input performance indexes until unselected candidate feature is emptied.

In some examples, before the preset termination condition is satisfied, if the combined model input performance index of the candidate feature satisfies the preset selection condition and the difference from the combined model input performance index of the previous model input feature is less than a preset difference threshold, a correlation parameter between the candidate feature and the previous model input feature is obtained; and if the correlation parameter exceeds a preset correlation range, the candidate feature is determined as a non-model input feature.

The combined model input performance index of the candidate feature satisfies the preset selection condition, indicating that the candidate feature may be used as a model input feature. The difference in the combined model input performance index between the candidate feature and the previous model input feature is less than the preset difference threshold, indicating that the difference between the candidate feature and the previously selected model input feature is small and that there may be a strong correlation between the two. Such correlation between the candidate feature and the previous model input feature needs to be further detected. The preset difference threshold is used to filter candidate features that require correlation detection, and may be set according to, but not limited to, scenarios, needs, experience, etc. For example, the preset difference threshold is 10-5. The correlation parameter may characterize the correlativity. The preset correlation range is used to filter out candidate features that have the strong correlativity with the previous model input feature, and may be set according to, but not limited to, scenarios, needs, experience, etc. The non-model input feature refers to a candidate feature that is not a model input feature, including the candidate feature filtered out by using the preset correlation range. In some cases, the correlation parameter is positively correlated with the correlativity, that is, the larger correlation parameter indicates the stronger correlativity. For example, the correlativity between the candidate feature and the previous model input feature is checked by using a Pearson correlation coefficient. If the correlation parameter is more than 0.7, the candidate feature has a strong positive correlativity with the previous model input feature, and the candidate feature is determined as a non-model input feature. In some cases, the correlation parameter is negatively correlated with the correlation, that is, the smaller correlation parameter indicates the stronger correlativity. For example, the correlativity between the candidate feature and the previous model input feature is checked by using a Pearson correlation coefficient. If the correlation parameter is less than −0.7, the candidate feature has a strong negative correlativity with the previous model input feature, and the candidate feature is determined as a non-model input feature.

By checking the correlation parameter, the selection of model input features can be further optimized, and the effectiveness and adaptability of model input feature selection can be improved, thereby improving the accuracy of the model trained with the model input features.

In the embodiments of the present application, the problem of missing model input performance evaluation near the original binning point in the original binning method can be solved by adding only one or two hyperparameters and the first weight that corresponds to the first model input performance index. When the first proportion and the second proportion are the same, only one hyperparameter is added. When the first proportion and the second proportion are different, only two hyperparameters are added.

For ease of understanding, an example will be provided below to illustrate the process of the foregoing method for selecting a model input feature. FIG. 6 is a flowchart of an example of a process of selecting a model input feature provided in an embodiment of the present application. As shown in FIG. 6, the process of selecting a model input feature may include steps S201 to S209.

In step S201, components of a model input performance index, a candidate feature, and an original bin corresponding to the candidate feature are determined.

In step S202, a critical bin is constructed based on an original binning point for the original bin.

In step S203, the model input performance index of the candidate feature in the critical bin and the model input performance index of the candidate feature in the original bin are calculated.

In step S204, a combined model input performance index of the candidate feature is calculated according to weights corresponding to the model input performance index of the candidate feature in the critical bin and the model input performance index of the candidate feature in the original bin.

In step S205, it is determined whether the calculation of the combined model input performance indexes of all candidate features has been completed. If the calculation is completed, step S206 will be performed; or if the calculation is not completed, step S202 will be performed again.

In step S206, the candidate features are arranged in order of the combined model input performance indexes.

In step S207, the model input feature is selected, and the candidate feature strongly correlated with the previous model input feature is filtered out.

In step S208, it is determined whether a preset termination condition is satisfied. If the preset termination condition is satisfied, step S209 will be performed; or if the preset termination condition is not satisfied, step S207 will be performed again.

In step S209, the selection of the model input feature is terminated to obtain the selected model input feature.

The specific content of steps S201 to S209 may be referred to the relevant explanations in the foregoing embodiments, and will not be repeated here.

The method for selecting a model input feature in the foregoing embodiments may be used for selecting the model input feature in various scenarios. For example, the method may be used in scenarios such as default determination, risk management and control, and fault identification, which is not limited herein.

It should be noted that the acquisition, storage, use, processing, etc. of information and data in the embodiments of the present application are authorized by users or relevant institutions and comply with relevant national laws and regulations.

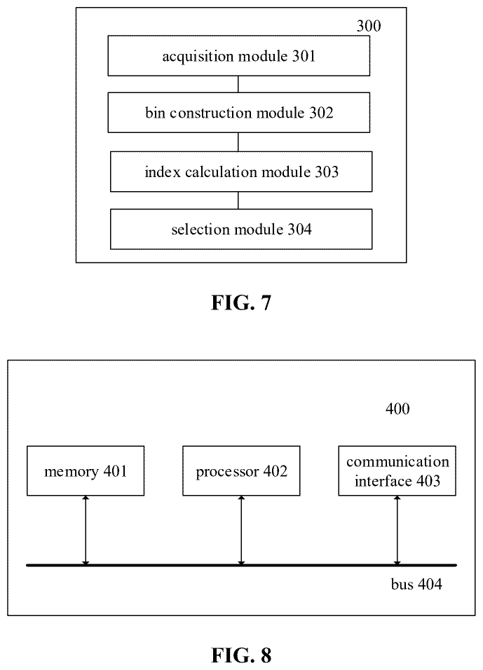

In a second aspect, the present application provides an apparatus for selecting a model input feature. FIG. 7 is a schematic structural diagram of an apparatus for selecting a model input feature provided in an embodiment of the present application. As shown in FIG. 7, the apparatus for selecting a model input feature 300 may include an acquisition module 301, a bin construction module 302, an index calculation module 303, and a selection module 304.

The acquisition module 301 may be configured to acquire a candidate feature, feature data including the candidate feature, and an original binning point of an original bin for a value of the candidate feature.

The bin construction module 302 may be configured to construct a critical bin according to the original binning point, where the critical bin is obtained by extension from the original binning point into two corresponding adjacent original bins.

The index calculation module 303 may be configured to obtain a first model input performance index according to the value of the candidate feature in the feature data and the critical bin.

The first model input performance index includes a model input performance index of the candidate feature in the critical bin.

The selection module 304 may be configured to select the model input feature from the candidate feature according to the first model input performance index of the candidate feature and pre-acquired second model input performance index of the candidate feature.

The second model input performance index includes a model input performance index of the candidate feature in the original bins.

In some examples, the model input performance index may include at least one of: an information value, a population stability index, a KS statistic, or an area under curve.

In the embodiments of the present application, based on the original binning point of the original bin for the candidate feature, the critical bin is obtained by extension from the original binning point into two corresponding adjacent original bins, the first model input performance index of the candidate feature in the critical bin is obtained according to the value of the candidate feature in the feature data and the critical bin, and the model input features are selected from the candidate features according to the first model input performance indexes and second model input performance indexes of the candidate features. The original binning point and the values near the original binning point are within the critical bin, and the first model input performance index may reflect the performance of the candidate feature in the critical bin, so the first model input performance index may be used to compensate for missing evaluation of the original binning point and the values near the original binning point by the second model input performance index that reflects the performance of the candidate feature in the original bin. The combination of the first model input performance index and the second model input performance index can evaluate the candidate features more comprehensively and accurately, complete the selection process of model input features, and improve the effectiveness of model input feature selection, thereby improving the accuracy and stability of a model trained with the selected model input features. Especially in linear model application scenarios such as logistic regression, the classification accuracy of the model trained with the selected model input features for adversarial samples can further be enhanced.

Moreover, the method for selecting a model input feature in the embodiments of the present application does not need to determine a data offset of the original bin, or adjust the evaluation on the feature in the original bin, or modify the evaluation process of the original bin, but can achieve better effects under the condition of minimal influence on the original architecture of model input feature selection. The method for selecting a model input feature in the embodiments of the present application may be applied to a federated modeling scenario. The determination of model input features does not require additional model training, which can reduce the overhead, especially in the federated modeling scenario.

In some embodiments, the bin construction module 302 may be configured to: extend from the original binning point into one of the corresponding adjacent original bins in a preset first proportion to obtain a first range, where the first proportion is a ratio of the first range to a range of the one of the corresponding adjacent original bins; extend from the original binning point into the other one of the corresponding adjacent original bins in a preset second proportion to obtain a second range, where the second proportion is a ratio of the second range to a range of the other one of the corresponding adjacent original bins; and merge the first range and the second range to obtain the critical bin.

In some examples, the first proportion is less than or equal to 10%, and the second proportion is less than or equal to 10%.

In some embodiments, the index calculation module 303 may be configured to: acquire, according to the value of the candidate feature in the feature data and the critical bin, a quantity of feature data in which the value of the candidate feature is located in the critical bin; and obtain the first model input performance index according to the quantity of feature data in which the value of the candidate feature is within the critical bin.

In some examples, the feature data has classification labels, and the classification labels are for indicating classification results of the feature data. The index calculation module 303 may be configured to: acquire, from the feature data in the critical bin, a first quantity of feature data having the same classification label; acquire, from the feature data, a second quantity of feature data having the same classification label; and obtain the first model input performance index according to the first quantity and the second quantity.

In some examples, the classification labels include a first classification label and a second classification label, and the first classification label and the second classification label indicate different classification results. The index calculation module 303 may be configured to: acquire a first ratio of the first quantity corresponding to the first classification label to the second quantity corresponding to the first classification label; acquire a second ratio of the first quantity corresponding to the second classification label to the second quantity corresponding to the second classification label; and obtain the first model input performance index according to the first ratio and the second ratio.

In some examples, the classification labels include a first classification label to an N-th classification label, where N is an integer greater than 2, and the first classification label to the N-th classification label indicate different classification results. The index calculation module 303 may be configured to: calculate, for each of every two classification labels from the first classification label to the N-th classification label, a model input performance factor term corresponding to two classification labels according to ratios of the first quantity to the second quantity corresponding to two classification labels; and determine a sum of the model input performance factor terms corresponding to every two classification labels from the first classification label to the N-th classification label as the first model input performance index.

In some embodiments, the selection module 304 may be configured to: acquire a first weight of the first model input performance index and a second weight of the second model input performance index; obtain a combined model input performance index of the candidate feature by using a weighting algorithm according to the first model input performance index, the first weight, the second model input performance index, and the second weight; and select the model input feature from the candidate feature according to the combined model input performance index.

In some examples, the selection module 304 may be configured to: sequentially determine the candidate feature as the model input feature in descending order of performances represented by the combined model input performance index until a preset termination condition is satisfied.

In some examples, the selection module 304 may further be configured to: before the preset termination condition is satisfied, if the combined model input performance index of the candidate feature satisfies a preset selection condition and the difference from the combined model input performance index of the previous model input feature is less than a preset difference threshold, acquire a correlation parameter between the candidate feature and the previous model input feature; and if the correlation parameter exceeds a preset correlation range, determine the candidate feature as a non-model input feature.

In a third aspect, the present application provides an electronic device. FIG. 8 is a schematic structural diagram of an electronic device provided in an embodiment of the present application. As shown in FIG. 8, the electronic device 400 includes a memory 401, a processor 402, and a computer program stored in the memory 401 and executable on the processor 402.

In some examples, the processor 402 may include a central processing unit (CPU), or an application specific integrated circuit (ASIC), or may be configured as one or more integrated circuits to implement the embodiments of the present application.

The memory 401 may be a read-only memory (ROM), a random access memory (RAM), a magnetic disk storage medium device, an optical storage medium device, a flash memory device, or an electrical, optical, or other physical/tangible memory device. Generally, the memory includes one or more tangible (non-transient) computer-readable storage media (such as memory devices) encoded with software including computer executable instructions, and the software, when executed (such as by one or more processors), is operable to perform the operations described with reference to the method for selecting a model input feature in the embodiments of the present application.

The processor 402 reads executable program code stored in the memory 401 to run the computer program corresponding to the executable program code, so as to implement the method for selecting a model input feature in the foregoing embodiments.

In some examples, the electronic device 400 may further include a communication interface 403 and a bus 404. As shown in FIG. 8, the memory 401, the processor 402, and the communication interface 403 are connected and communicate with each other through the bus 404.

The communication interface 403 is mainly configured to implement communication between various modules, apparatuses, units, and/or devices in the embodiments of the present application. Input and/or output devices may also be connected through the communication interface 403.

The bus 404 includes hardware, software, or both, and couples the components of the electronic device 400 together. By way of example but not limitation, the bus 404 may be an accelerated graphics port (AGP) or other graphics bus, an enhanced industry standard architecture (EISA) bus, a front side bus (FSB), a hyper transport (HT) interconnect, an industry standard architecture (ISA) bus, an infinite bandwidth interconnect, a low pin count (LPC) bus, a memory bus, a micro channel architecture (MCA) bus, a peripheral component interconnect (PCI) bus, a PCI-Express (PCI-E) bus, a serial advanced technology attachment (SATA) bus, a video electronics standards association local (VLB) bus, or any other suitable bus, or a combination of two or more of the above. Where appropriate, the bus 404 may include one or more buses. Although the embodiments of the present application describe and show a specific bus, the present application considers any suitable bus or interconnect.

A fourth aspect of the present application provides a computer-readable storage medium, the computer-readable storage medium storing computer program instructions, which, when executed by a processor, are capable of implementing the method for selecting a model input feature in the foregoing embodiments and achieving the same technical effects. To avoid repetition, details will not be described herein. The computer-readable storage medium may include non-transient computer-readable storage media, such as a read-only memory (ROM), a random access memory (RAM), a magnetic disk, or an optical disk, which is not limited herein.

An embodiment of the present application provides a computer program product, instructions in the computer program product, when executed by a processor of an electronic device, enabling the electronic device to perform the method for selecting a model input feature in the foregoing embodiments and achieving the same technical effects. To avoid repetition, details will not be described herein.

It should be noted that the various embodiments in this specification are described in a progressive manner, the same or similar parts between the various embodiments may refer to each other, and each embodiment focuses on the differences from other embodiments. For the embodiments of the apparatus, the device, the computer-readable storage medium, and the computer program product, relevant parts can refer to the description section of the embodiments of the method. The present application is not limited to the specific steps and structures described above and shown in the figures. Those skilled in the art can make various changes, modifications, and additions, or change the order of steps after understanding the spirit of the present application. And, for the sake of simplicity, detailed descriptions of known methods and technologies are omitted here.

The above describes various aspects of the present application with reference to the flowchart and/or block view of the method, apparatus (system), and computer program product according to the embodiments of the present application. It should be understood that each box in the flowchart and/or block view and a combination of boxes in the flowchart and/or block view can be implemented by computer program instructions. These computer program instructions can be provided to a processor of a general-purpose computer, a dedicated computer, or other programmable data processing apparatuses to produce a machine, which enables the instructions executed by the processor of the computer or other programmable data processing apparatuses to implement the functions/actions specified in one or more boxes of the flowchart and/or block view. Such a processor may be, but is not limited to a general-purpose processor, a dedicated processor, a special application processor, or a field programmable logic circuit. It can also be understood that each box in the block view and/or flowchart and a combination of boxes in the block view and/or flowchart can be implemented by dedicated hardware that executes specified functions or actions, or by a combination of dedicated hardware and computer instructions.

Those skilled in the art should understand that the above embodiments are all illustrative but not restrictive. Different technical features appearing in different embodiments can be combined to achieve beneficial effects. Those skilled in the art should be able to understand and implement other modified embodiments of the disclosed embodiments after studying the drawings, description, and claims. In the claims, the term “comprise” does not exclude other apparatuses or steps; the quantifier “one” does not exclude more; and the terms “first” and “second” are used to denote names rather than to indicate any specific order. Any reference numerals in the claims should not be construed as limiting the scope of protection. The functions of a plurality of portions appearing in the claims can be implemented by a single hardware or software module. The appearance of some technical features in different dependent claims does not mean that these technical features cannot be combined to achieve beneficial effects.

1. A method for selecting a model input feature, comprising:
acquiring a candidate feature, feature data comprising the candidate feature, and an original binning point of an original bin for a value of the candidate feature;
constructing a critical bin based on the original binning point, wherein the critical bin is obtained by extension from the original binning point into two corresponding adjacent original bins;
obtaining a first model input performance index according to the value of the candidate feature in the feature data and the critical bin, wherein the first model input performance index comprises a model input performance index of the candidate feature in the critical bin; and
selecting the model input feature from the candidate feature according to the first model input performance index of the candidate feature and a pre-acquired second model input performance index of the candidate feature, wherein the second model input performance index comprises a model input performance index of the candidate feature in the original bin.

2. The method according to claim 1, wherein the constructing a critical bin based on the original binning point comprises:
extending from the original binning point into one of the two corresponding adjacent original bins in a preset first proportion to obtain a first range, wherein the first proportion is a ratio of the first range to a range of the one of the two corresponding adjacent original bins;
extending from the original binning point into the other one of the two corresponding adjacent original bins in a preset second proportion to obtain a second range, wherein the second proportion is a ratio of the second range to a range of the other one of the two corresponding adjacent original bins; and
merging the first range and the second range to obtain the critical bin.

3. The method according to claim 2, wherein
the first proportion is less than or equal to 10%, and the second proportion is less than or equal to 10%.

4. The method according to claim 1, wherein the obtaining a first model input performance index according to the value of the candidate feature in the feature data and the critical bin comprises:
acquiring, according to the value of the candidate feature in the feature data and the critical bin, a quantity of the feature data in which the value of the candidate feature is within the critical bin; and
obtaining the first model input performance index according to the quantity of the feature data in which the value of the candidate feature is within the critical bin.

5. The method according to claim 4, wherein
the feature data has classification labels indicating classification results of the feature data, and
the obtaining the first model input performance index according to the quantity of the feature data in which the value of the candidate feature is within the critical bin comprises:
acquiring, from the feature data in the critical bin, a first quantity of the feature data having a same classification label of the classification labels;
acquiring, from the feature data, a second quantity of the feature data having a same classification label of the classification labels; and
obtaining the first model input performance index according to the first quantity and the second quantity.

6. The method according to claim 5, wherein
the classification labels comprise a first classification label and a second classification label, the first classification label and the second classification label indicating different classification results, respectively, and
the obtaining the first model input performance index according to the first quantity and the second quantity comprises:
acquiring a first ratio of the first quantity corresponding to the first classification label to the second quantity corresponding to the first classification label;
acquiring a second ratio of the first quantity corresponding to the second classification label to the second quantity corresponding to the second classification label; and
obtaining the first model input performance index according to the first ratio and the second ratio.

7. The method according to claim 5, wherein
the classification labels comprise a first classification label to an N-th classification label, where N is an integer greater than 2, and the first classification label to the N-th classification label indicate different classification results, and
the obtaining the first model input performance index according to the first quantity and the second quantity comprises:
calculating, for each of every two classification labels from the first classification label to the N-th classification label, a model input performance factor term corresponding to the two classification labels according to ratios of the first quantity to the second quantity respectively corresponding to the two classification labels; and
determining a sum of the model input performance factor terms corresponding to the every two classification labels from the first classification label to the N-th classification label as the first model input performance index.

8. The method according to claim 1, wherein the selecting the model input feature from the candidate feature according to the first model input performance index of the candidate feature and a pre-acquired second model input performance index of the candidate feature comprises:
acquiring a first weight of the first model input performance index and a second weight of the second model input performance index;
obtaining a combined model input performance index of the candidate feature by using a weighting algorithm according to the first model input performance index, the first weight, the second model input performance index, and the second weight; and
selecting the model input feature from the candidate feature according to the combined model input performance index.

9. The method according to claim 8, wherein the selecting the model input feature from the candidate feature according to the combined model input performance index comprises:
sequentially determining the candidate feature as the model input feature in descending order of performance characterized by the combined model input performance index until a preset termination condition is satisfied.

10. The method according to claim 9, further comprising:
before the preset termination condition is satisfied, if the combined model input performance index of the candidate feature satisfies a preset selection condition and a difference from the combined model input performance index of the previous model input feature is less than a preset difference threshold, acquiring a correlation parameter between the candidate feature and the previous model input feature; and
if the correlation parameter exceeds a preset correlation range, determining the candidate feature as a non-model input feature.

11. The method according to claim 1, wherein the model input performance index comprises at least one of:
an information value, a population stability index, a KS statistic, or an area under curve.

12. An apparatus for selecting a model input feature, comprising:
an acquisition module, configured to acquire a candidate feature, feature data comprising the candidate feature, and an original binning point of an original bin for a value of the candidate feature;
a bin construction module, configured to construct a critical bin based on the original binning point, wherein the critical bin is obtained by extension from the original binning point into two corresponding adjacent original bins;
an index calculation module, configured to obtain a first model input performance index according to the value of the candidate feature in the feature data and the critical bin, wherein the first model input performance index comprises a model input performance index of the candidate feature in the critical bin; and
a selection module, configured to select the model input feature from the candidate feature according to the first model input performance index of the candidate feature and a pre-acquired second model input performance index of the candidate feature, wherein the second model input performance index comprises a model input performance index of the candidate feature in the original bin.

13. An electronic device, comprising: a processor and a memory storing computer program instructions, wherein
the processor, when executing the computer program instructions, implements the method for selecting a model input feature comprising:
acquiring a candidate feature, feature data comprising the candidate feature, and an original binning point of an original bin for a value of the candidate feature;
constructing a critical bin based on the original binning point, wherein the critical bin is obtained by extension from the original binning point into two corresponding adjacent original bins;
obtaining a first model input performance index according to the value of the candidate feature in the feature data and the critical bin, wherein the first model input performance index comprises a model input performance index of the candidate feature in the critical bin; and
selecting the model input feature from the candidate feature according to the first model input performance index of the candidate feature and a pre-acquired second model input performance index of the candidate feature, wherein the second model input performance index comprises a model input performance index of the candidate feature in the original bin.

14. A tangible computer-readable storage medium, the computer-readable storage medium storing computer program instructions, and the computer program instructions, when executed by a processor, implementing the method for selecting a model input feature according to claim 1.
